(19) United States
(12) Patent Application Publication
(10) Pub. No.: US 2024/0338284 A1
(43) Pub. Date: Oct. 10, 2024

(54) MODULAR REDUNDANCY

(71) Applicant: Apple Inc., Cupertino, CA (US)

(72) Inventors: Ryan J. ALLEN, San Diego, CA (US); Christopher Y. BROWN, San Jose, CA (US); Jeffrey D. KOFTINOFF, Menlo Park, CA (US); George E. WILLIAMS, Pleasanton, CA (US)

(21) Appl. No.: 18/443,213

(22) Filed: Feb. 15, 2024

Related U.S. Application Data
(60) Provisional application No. 63/458,012, filed on Apr. 7, 2023.

(51) Int. Cl. G06F 11/18

(52) U.S. Cl. CPC G06F 11/183

(57) ABSTRACT

This disclosure provides more effective and/or efficient techniques for implementing redundancy. For example, some techniques include a voting service that receives output from processes executing on three different hardware devices to determine which output to provide to a consumer of the output. Such techniques are optimized through where the voting service is located, what is received by the voting service, how processes are executed on the three different hardware devices, and how output is provided to the consumer, as further discussed herein. Such techniques optionally complement or replace other methods for implementing redundancy.

### CROSS-REFERENCE TO RELATED APPLICATIONS

The present application claims priority to U.S. Provisional Patent Application Ser. No. 63/458,012, entitled “MODULAR REDUNDANCY” filed Apr. 7, 2023, which is hereby incorporated by reference in its entirety for all purposes.

### BACKGROUND

Redundancy is a common approach to improve the reliability and/or availability of a software program. For example, modular redundancy refers to the approach of having multiple devices perform an operation and the results from the performances of the operation are processed by a majority-voting system to produce a single output. Such modular redundancy is often used to detect hardware failures, caused by for example gamma rays, aging, overheating, and/or power supply glitches.

### SUMMARY

Current techniques for implementing redundancy for a software program are generally ineffective and/or inefficient. This disclosure provides more effective and/or efficient techniques for implementing redundancy. For example, some techniques include a voting service that receives output from processes executing on different hardware devices to determine which output to provide to a consumer of the output. Such techniques are optimized according to where the voting service is located, what is received by the voting service, how processes are executed on the three different hardware devices, and how output is provided to the consumer, as further discussed herein. Such techniques optionally complement or replace other methods for implementing redundancy.

In some examples, a method is described that is performed by a voting service. In some examples, the method comprises: receiving, from a process executing on a first hardware device, first validation data corresponding to execution of a first instance of a first portion of a software program on the first hardware device; receiving, from a process executing on a second hardware device different from the first hardware device, second validation data corresponding to execution of a second instance of the first portion of the software program on the second hardware device; identifying valid execution data based on a comparison of the first validation data and the second validation data, wherein the valid execution data is output by the first hardware device, the second hardware device, or a third hardware device; and in response to identifying the valid execution data, causing an operation of the software program to be performed using the valid execution data.

In some examples, a non-transitory computer-readable storage medium storing one or more programs configured to be executed by one or more processors of a computer system is described. In some examples, the one or more programs includes instructions for: receiving, from a process executing on a first hardware device, first validation data corresponding to execution of a first instance of a first portion of a software program on the first hardware device; receiving, from a process executing on a second hardware device different from the first hardware device, second validation data corresponding to execution of a second instance of the first portion of the software program on the second hardware device; identifying valid execution data based on a comparison of the first validation data and the second validation data, wherein the valid execution data is output by the first hardware device, the second hardware device, or a third hardware device; and in response to identifying the valid execution data, causing an operation of the software program to be performed using the valid execution data.

In some examples, a transitory computer-readable storage medium storing one or more programs configured to be executed by one or more processors of a computer system is described. In some examples, the one or more programs includes instructions for: receiving, from a process executing on a first hardware device, first validation data corresponding to execution of a first instance of a first portion of a software program on the first hardware device; receiving, from a process executing on a second hardware device different from the first hardware device, second validation data corresponding to execution of a second instance of the first portion of the software program on the second hardware device; identifying valid execution data based on a comparison of the first validation data and the second validation data, wherein the valid execution data is output by the first hardware device, the second hardware device, or a third hardware device; and in response to identifying the valid execution data, causing an operation of the software program to be performed using the valid execution data.

In some examples, a computer system is described. In some examples, the computer system comprises one or more processors and memory storing one or more program configured to be executed by the one or more processors. In some examples, the one or more programs includes instructions for: receiving, from a process executing on a first hardware device, first validation data corresponding to execution of a first instance of a first portion of a software program on the first hardware device; receiving, from a process executing on a second hardware device different from the first hardware device, second validation data corresponding to execution of a second instance of the first portion of the software program on the second hardware device; identifying valid execution data based on a comparison of the first validation data and the second validation data, wherein the valid execution data is output by the first hardware device, the second hardware device, or a third hardware device; and in response to identifying the valid execution data, causing an operation of the software program to be performed using the valid execution data.

In some examples, a computer system is described. In some examples, the computer system comprises means for performing each of the following steps: receiving, from a process executing on a first hardware device, first validation data corresponding to execution of a first instance of a first portion of a software program on the first hardware device; receiving, from a process executing on a second hardware device different from the first hardware device, second validation data corresponding to execution of a second instance of the first portion of the software program on the second hardware device; identifying valid execution data based on a comparison of the first validation data and the second validation data, wherein the valid execution data is output by the first hardware device, the second hardware device, or a third hardware device; and in response to identifying the valid execution data, causing an operation of the software program to be performed using the valid execution data.

In some examples, a computer program product is described. In some examples, the computer program product comprises one or more programs configured to be executed by one or more processors of a computer system. In some examples, the one or more programs include instructions for: receiving, from a process executing on a first hardware device, first validation data corresponding to execution of a first instance of a first portion of a software program on the first hardware device; receiving, from a process executing on a second hardware device different from the first hardware device, second validation data corresponding to execution of a second instance of the first portion of the software program on the second hardware device; identifying valid execution data based on a comparison of the first validation data and the second validation data, wherein the valid execution data is output by the first hardware device, the second hardware device, or a third hardware device; and in response to identifying the valid execution data, causing an operation of the software program to be performed using the valid execution data.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a compute system.

FIG. 2 is a block diagram illustrating a device with interconnected subsystems.

FIG. 3 is a block diagram illustrating execution of a software program in a multi-device system.

FIG. 4 is a block diagram illustrating triple-modular redundancy using a multi-device system with a voting service executing on the same device as a consumer.

FIG. 5 is a block diagram illustrating triple-modular redundancy using a multi-device system with a voting service executing on a different device than a consumer.

FIG. 6 is a flow diagram illustrating a method for implementing redundancy in accordance with some examples described herein.

### DETAILED DESCRIPTION

The following description sets forth exemplary techniques, methods, parameters, systems, computer-readable storage mediums, and the like. It should be recognized, however, that such description is not intended as a limitation on the scope of the present disclosure. Instead, such description is provided as a description of exemplary embodiments.

Methods described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” etc. to describe various elements, these elements should not be limited by the terms. In some examples, these terms are used to distinguish one element from another. For example, a first subsystem could be termed a second subsystem, and, similarly, a subsystem device could be termed a subsystem device, without departing from the scope of the various described embodiments. In some examples, the first subsystem and the second subsystem are two separate references to the same subsystem. In some embodiments, the first subsystem and the second subsystem are both subsystem, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

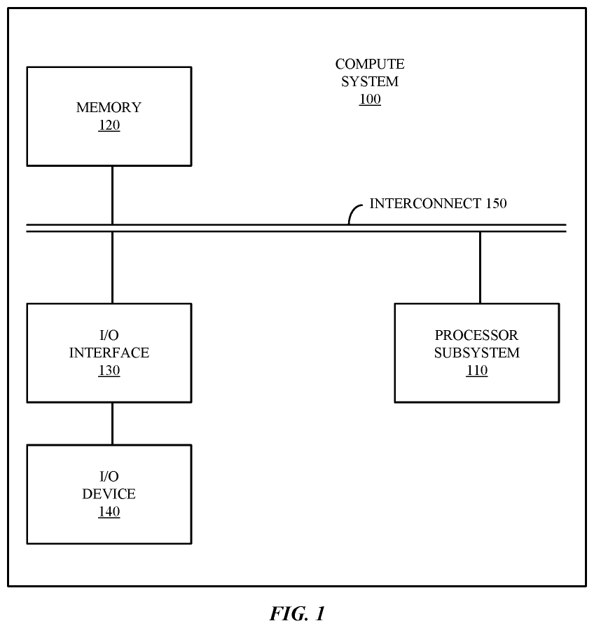

Turning to FIG. 1, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some examples, I/O interface 130 is included with I/O device 140 such that the two are a single component. It should be recognized that there can be one or more I/O interfaces, with each I/O interface communicating with one or more I/O devices. In some examples, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some examples, compute system 100 is included or communicating with a physical component for the purpose of modifying the physical component in response to an instruction. In some examples, compute system 100 receives an instruction to modify a physical component and, in response to the instruction, causes the physical component to be modified. In some examples, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some examples, a sensor includes one or more hardware components that detect information about a physical environment in proximity to (e.g., surrounding) the sensor. In some examples, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some examples, a sensor includes a combination of multiple sensors. In some examples, sensor data is captured by fusing data from one sensor with data from one or more other sensors. Although a single compute system is shown in FIG. 1, compute system 100 can also be implemented as two or more compute systems operating together.

In some examples, processor subsystem 110 includes one or more processors or processing units configured to execute program instructions to perform functionality described herein. For example, processor subsystem 110 can execute an operating system, a middleware system, one or more applications, or any combination thereof.

In some examples, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive executive (AIX), network operating systems (e.g., Microsoft Windows Server), and real-time operating systems (e.g., QNX). In some examples, the operating system includes various procedures, sets of instructions, software components, and/or drivers for controlling and managing general system tasks (e.g., memory management, storage device control, power management, or the like) and for facilitating communication between various hardware and software components. In some examples, the operating system uses a priority-based scheduler that assigns a priority to different tasks that processor subsystem 110 can execute. In such examples, the priority assigned to a task is used to identify a next task to execute. In some examples, the priority-based scheduler identifies a next task to execute when a previous task finishes executing. In some examples, the highest priority task runs to completion unless another higher priority task is made ready.

In some examples, the middleware system provides one or more services and/or capabilities to applications (e.g., the one or more applications running on processor subsystem 110) outside of what the operating system offers (e.g., data management, application services, messaging, authentication, API management, or the like). In some examples, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some examples, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some examples, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some examples, the first node notifies the second node that the data has been stored in the memory by sending a pointer (e.g., a memory pointer, such as an identification of a memory location) to the second node so that the second node can access the data from where the first node stored the data. In some examples, the first node would send the data directly to the second node so that the second node would not need to access a memory based on data received from the first node.

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with methods 800, 900, 1000, 11000, 12000, 1300, 1400, and 1500 described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some examples, these other forms of storage can also store program instructions executable by processor subsystem 110 to perform operations described herein. In some examples, processor subsystem 110 (or each processor within processor subsystem 110) contains a cache or other form of on-board memory.

I/O interface 130 can be any of various types of interfaces configured to communicate with other devices. In some examples, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some examples, compute system 100 is communicating with a network via a network interface device (e.g., configured to communicate over Wi-Fi, Bluetooth, Ethernet, or the like). In some examples, compute system 100 is directly or wired to the network.

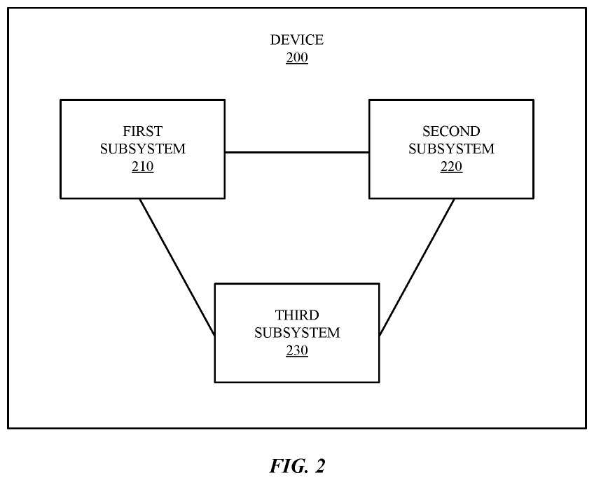

FIG. 2 illustrates a block diagram of device 200 with interconnected subsystems. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1 (i.e., compute system 100). Although three subsystems are shown in FIG. 2, device 200 can include more or fewer subsystems.

In some examples, some subsystems are not connected to other subsystem (e.g., first subsystem 210 can be connected to second subsystem 220 and third subsystem 230 but second subsystem 220 cannot be connected to third subsystem 230). In some examples, some subsystems are connected via one or more wires while other subsystems are wirelessly connected. In some examples, messages are set between the first subsystem 210, second subsystem 220, and third subsystem 230, such that when a respective subsystem sends a message the other subsystems receive the message (e.g., via a wire and/or a bus). In some examples, one or more subsystems are wirelessly connected to one or more compute systems outside of device 200, such as a server system. In such examples, the subsystem can be configured to communicate wirelessly to the one or more compute systems outside of device 200.

In some examples, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some examples, device 200 is configured to navigate (with or without user input) in a physical environment.

In some examples, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some examples, at least a portion of device 200 functions as a distributed compute system. For example, a task can be split into different portions, where a first portion is executed by first subsystem 210 and a second portion is executed by second subsystem 220.

Attention is now directed towards techniques for implementing redundancy. Such techniques are described in the context of a system with different devices, each executing a portion of a software program. It should be understood that other types of systems are within scope of this disclosure and can benefit from techniques described herein. For example, a single device can execute the portion of the software program multiple times in parallel instead of different devices each executing the portion of the software program.

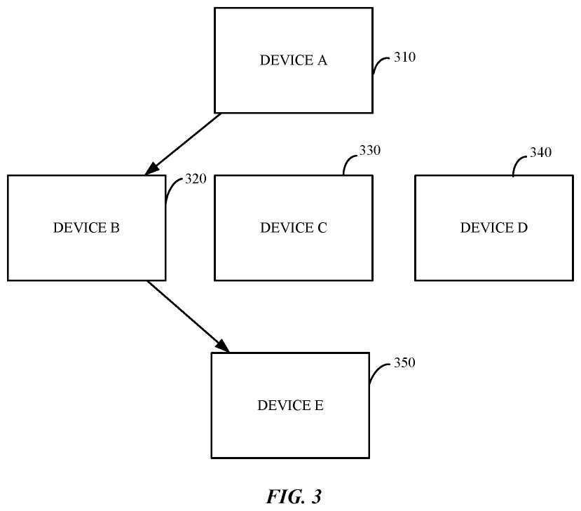

FIG. 3 is a block diagram illustrating execution of a software program in a multi-device system. As illustrated, the multi-device system includes device A 310, device B 320, device C 330, device D 340, and device E 350. Each device in the multi-device system can include one or more features described above in relation to compute system 100 and/or device 200. In some examples, one or more devices in the multi-device system is a different type of device than one or more other devices in the multi-device system. For example, device B 320 can include a different amount of memory and/or processors as compared to device C 330. It should be recognized that techniques described herein can be performed on multi-device systems with more or fewer devices and/or systems with different configurations than illustrated in FIG. 3.

The software program described with respect to FIG. 3 includes a set of instructions that executes on multiple devices included in the multi-device system. For example, the software program can include one or more instructions executable by device A 310 to capture an image, one or more instructions executable by device B 320 to calculate a result using the image, and one or more instructions executable by device E 350 to actuate a component based on the result. In such an example, the image is sent from device A 310 to device B 320, and the calculated result is sent from device B 320 to device E 350. It should be recognized that techniques described herein can be performed with different types of software programs, with different types of communications, and/or without communications between devices.

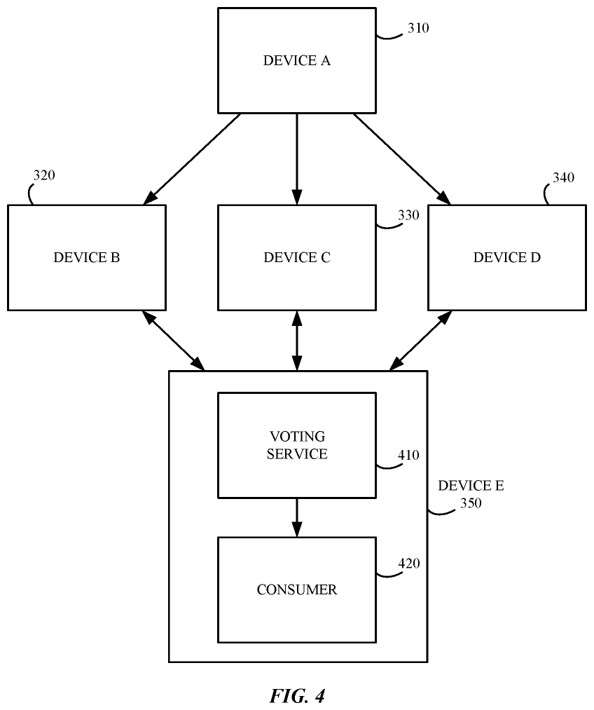

FIG. 4 is a block diagram illustrating triple-modular redundancy using a multi-device system (e.g., the multi-device system described in FIG. 3) with voting service 410 executing on the same device as consumer 420. The triple-modular redundancy includes duplicating at least a portion of a software program on multiple different devices (e.g., one or more instructions to calculate a result using an image, perform a mathematical computation, and/or compare data) and having voting service 410 receive data from each of the multiple different devices to determine which output is sent to consumer 420. While described as triple-modular redundancy, it should be recognized that any number of replications can be used, including two or more than three. In examples with two replications instead of three, voting service 410 only causes output to be sent to consumer 420 after data received from both devices match each other (in some examples, after the data does not match, no output is sent to consumer 420).

In some examples, some parts of the software program are not duplicated on different devices and, instead, are solely executed on one of the multiple different devices. In such examples, the parts of the software program that are not duplicated can still produce output (e.g., that is sent to consumer 420) but that output is not validated using triple-modular redundancy (e.g., not compared with data received from other devices). For example, the triple-modular redundancy validates part of the output but not all of the output from the different devices.

In FIG. 4, device E 350 is illustrated to include voting service 410 and consumer 420. It should be recognized that voting service 410, in other examples, can be executed on a voting device separate from device E 350 (e.g., such as a device separate from devices illustrated in FIG. 3). In such examples, voting service 410 on the voting device performs similar operations as described herein for voting service 410 on device E 350 except that voting service 410 on the voting device sends communications to consumer 420 through inter-device communications rather than intra-device communications.

In some examples, voting service 410 is added (1) to the software program during compilation of the software program and/or (2) to device E 350 during execution of the software program to facilitate the triple-modular redundancy. In such examples, voting service 410 and/or triple-modular redundancy does not need to be included in the original design of the software program and, instead, can be added after logic of the software program is defined. For example, one or more nodes of a graph application can be defined to produce an output with a set of inputs. In such an example, the one or more nodes do not need to include instructions for the triple-modular redundancy and, instead, can be executed on different devices and/or on the same device in parallel with voting service 410 receiving output of the one or more nodes before forwarding the output to another node (e.g., a consuming node).

As discussed above, voting service 410 receives data from other processes executing on other devices. In some examples, the data received from the other processes is at least a portion of the output that is forwarded to consumer 420. In such examples, the data can be less than the entire output to reduce amount of data sent between processes. In other examples, the data received from the other processes is a representation of the output (e.g., such as a hash or checksum of the output) so that voting service 410 can compare representations from different processes to confirm that at least two of the representations match (e.g., within a certain confidence interval and/or within a particular amount from). When two representations match, voting service 410 determines to use output corresponding to one of the two matching representations for consumer 420. In some examples, the output is sent to consumer 420 from voting service 410. In other examples, the output is stored by device E 350 in shared memory of device E 350 that is accessible by both voting service 410 and consumer 420 such that voting service 410 does not need to send the output to consumer 420. In other examples, the output is sent to consumer 420 from a process producing the output, such as a process executing on device B 320, device C 330, or device D 340. In such examples, the output does not need to be sent from voting service 410 to consumer 420.

In some examples, the output of each of the processes involved in the triple-modular redundancy does not need to be sent to device E 350. For example, only the output of one of the processes involved in the triple-modular redundancy is sent to device E 350 and, if the output is determined to be incorrect, another process of a device sends output determined to be correct to device E 350. In such an example, voting service 410 sends a request to one of the devices to send the correct output. For another example, only two of the three processes send output to device E 350 and whichever output is determined to match output of another of the three processes is sent to consumer 420.

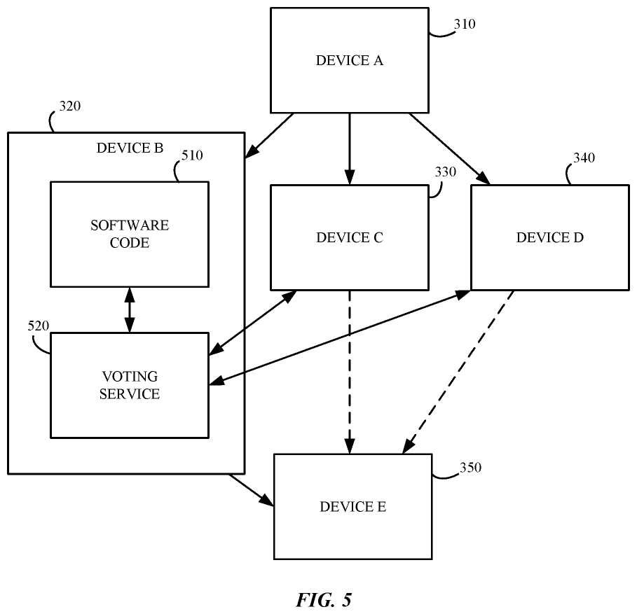

FIG. 5 is a block diagram illustrating triple-modular redundancy using a multi-device system (e.g., the multi-device system described in FIG. 3) with voting service 520 executing on a different device than a consumer node. As illustrated in FIG. 5, voting service 520 is executing on device B 320 along with software code 510. In some examples, software code 510 is a portion of a software program duplicated on each of device B 320, device C 330, and device D 340 as discussed above with respect to FIG. 4.

Similar to as described above with respect to FIG. 4, FIG. 5 illustrates that output of device A 310 is sent to device B 320. In some examples, software code 510 receives the output of device A 310 and performs one or more operations, including an operation based on the output of device A 310. In such examples, the one or more operations result in at least one output that is intended to be compared to output (e.g., at least a portion of the output or a representation of the output) from device C 330 and device D 340. In some examples, the output of software code 510 is stored locally on device B 320 (e.g., in shared memory) such that voting service 520 can access the output or a representation of the output (e.g., the representation is generated by software code 510) or generate a representation of the output without needing data to be sent by software code 510 to voting service 520. In other examples, software code 510 sends data (e.g., output and/or a representation of the output) to voting service 520 via intra-device communications.

In contrast to discussion above with respect to FIG. 4 (e.g., where device C 330 and device D 340 communicate with voting service 410 on device E 350), FIG. 5 illustrates that device C 330 and device D 340 send data (e.g., output and/or a representation of output) to voting service 520 on device B 320. In some examples, such data is a representation of output and output corresponding to the representation is either not sent to device B 320 (and instead sent to device E 350) or sent to device B 320 when it is determined that output stored on device B 320 by software code 510 is not valid (e.g., in response to a request sent by voting service 520 to device C 330 or device D 340).

In some examples with voting service 520 determining that output to send to device E 350 (e.g., the consumer executing on device E 350) is stored on device B 320, voting service 520 either sends the output to device E 350 or sends a request to software code 510 to send the output to device E 350. In examples with voting service 520 determining that output to send to device E 350 (e.g., the consumer executing on device E 350) is stored away from device B 320 (e.g., at device C 330 or device D 340), voting service 520 sends a request to either device B 320 or device E 350 for the output to be sent to device E 350.

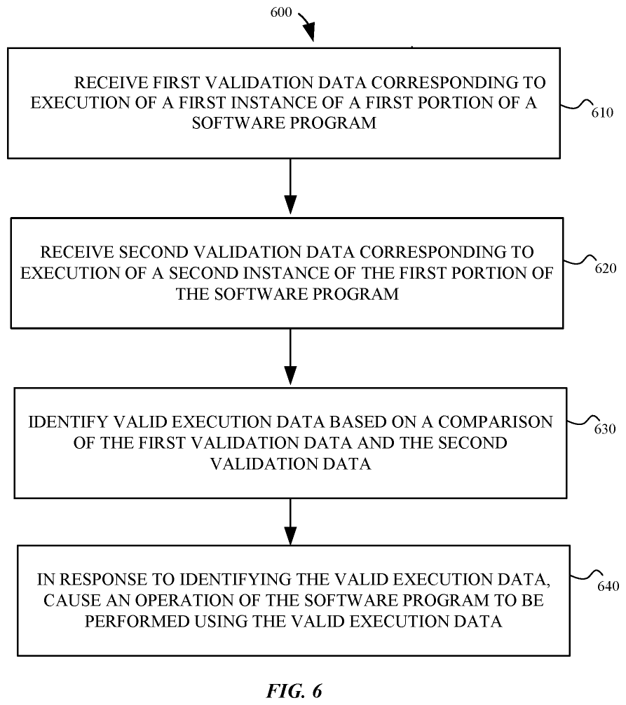

FIG. 6 is a flow diagram illustrating a method (e.g., method 600) for implementing redundancy in accordance with some examples described herein. In some examples, method 600 is a method for performing modular redundancy (e.g., triple modular redundancy, sometimes referred to as TMR) using at least a particular number of different hardware devices. In some examples, the different hardware devices are in communication with each other. In some examples, the different hardware devices are not in communication with each other and instead are in communication with (1) a fourth hardware device that instructs the three different hardware devices to execute and/or (2) a fifth hardware device that is configured to consume a valid output from one of the three different hardware devices. In some examples, method 600 is performed by a voting service (e.g., a voting node executing a voting process to identify valid data to be used when another process performs an operation). In some examples, the voting service can include one or more components and/or features of voting service 410 and/or 520 described above.

At 610, the voting service receives, from a process executing on a first hardware device, first validation data (e.g., execution data output by the first hardware device, a portion of the execution data that is not all of the execution data output (or to be output) by the first hardware device, checksum (e.g., a hash, a cryptographic hash, a data block, or any set of one or more values to confirm that two pieces of data are the same)) corresponding to execution of a first instance of a first portion of a software program on the first hardware device. In some examples, the software program is not configured before compiling to output the first validation data and instead output of the first validation data is added to the software program after initiating compiling of the software program (e.g., while compiling the software program or during execution of the software program).

At 620, the voting service receives, from a process executing on a second hardware device different from the first hardware device, second validation data corresponding to execution of a second instance of the first portion of the software program on the second hardware device. In some examples, the second hardware device is a different type of hardware device (e.g., at least one hardware component is different and/or includes a different capability (e.g., more memory)) than the first hardware device (and, in some examples, a third hardware device). In some examples, the second hardware device is not identical to the first hardware device (and, in some examples, a third hardware device). In some examples, the software program is not configured before compiling to output the second validation data and instead output of the second validation data is added to the software program (e.g., after initiating compiling of the software program (e.g., while compiling the software program or during execution of the software program)).

At 630, the voting service identifies valid execution data based on a comparison of the first validation data and the second validation data, where the valid execution data is output by the first hardware device, the second hardware device, or a third hardware device. In some examples, the valid execution data includes the first validation data, the second validation data, or third validation data received from a third hardware device. In some examples, the first hardware device, the second hardware device, and the third hardware device are all different types of devices.

At 640, in response to identifying the valid execution data, the voting service causes an operation (e.g., the operation is object detection, display of a user interface, calculation of a number, or any other type of operation) of the software program to be performed (e.g., by a fourth hardware device different from the first, second, and third hardware device; e.g., one of the first, second, or third hardware device) using the valid execution data.

In some examples, an instance of a second portion of the software program is executing on the first hardware device (e.g., one or more operations, such as an operation interlaced with the first operation; e.g., a user interface operation (an operation causing something to be displayed)). In some examples, an instance of the second portion of the software program is not executing (e.g., not duplicated or not running) on the second hardware device and the third hardware device (e.g., only the first portion of the software program is duplicated on the three hardware devices). In some examples, the second portion is executing on the second hardware device or the third hardware device and not the first hardware device.

In some examples, the voting service is executing on a hardware device performing the operation (e.g., a consumer of the valid execution data, such as the first, the second, the third, or a fourth hardware device). In some examples, the voting service identifies the valid execution data in response to receiving data (e.g., validation or execution data or an indication that execution data has been output) from only two hardware devices selected from a group consisting of the first hardware device, the second hardware device, and the third hardware device (e.g., the valid execution data is identified before receiving data (e.g., validation or execution data or an indication that execution data has been output) from a hardware device of the group consisting of the first hardware device, the second hardware device, and the third hardware device (“the group”)). In some examples, the data is validation data and the valid execution data is able to be identified by matching (e.g., exactly matching or matching within a certain degree of certainty) validation data received from two different hardware devices. In some examples, the data is execution data (or an indication of the execution data) and the hardware device performing the operation only receives such data from a single hardware device from the group such that other execution data is not output (e.g., in order to reduce network traffic, in order to reduce network latency, and/or in order increase network speeds).

In some examples, the voting service is executing on a hardware device performing the operation (e.g., a consumer of the valid execution data, such as the first, the second, the third, or a fourth hardware device). In some examples, the voting service identifies the valid execution data after receiving an indication of execution data from only one hardware device selected from a group consisting of the first hardware device, the second hardware device, and the third hardware device (e.g., the valid execution data is identified before receiving an indication of execution data from the other two hardware devices of the group). In some examples, the indication is the execution data. In some examples, the other two hardware devices have not output execution data and are waiting to receive instructions from the voting service.

In some examples, in response to determining that the valid execution data is different from execution data corresponding to the indication of execution data, the voting service sends, to a hardware device producing the valid execution data (e.g., the first, second, or third hardware device), a request to output the valid execution data. In some examples, in response to determining that the valid execution corresponds to the indication of execution data, forgoing sending a request to output the valid execution data (because, in some examples, the validation execution data has already been output).

In some examples, in accordance with a determination that the valid execution data is stored in shared memory of the voting service, the voting service causes the operation to be performed includes outputting (e.g., by the voting service) the valid execution data to a consumer (e.g., a software program, a hardware device (in some examples, different from the first hardware device, the second hardware device, and the third hardware device), and/or a service) of the valid execution data. In some examples, the voting service is executing on a hardware device selected from a group consisting of the first hardware device, the second hardware device, and the third hardware device. In some examples, in accordance with a determination that the valid execution data is stored on a device not executing the voting service, causing the operation to be performed includes sending an indication of the valid execution data to a process consuming the valid execution data.

In some examples, at least one hardware device selected from a group of hardware devices consisting of the first hardware device, the second hardware device, and the third hardware device is a different type of hardware device (e.g., the three hardware devices are not identical and/or are the same).

In some examples, the validation data is a checksum of at least a portion of execution data.

In some examples, the voting service receives, from a process executing on a third hardware device different from the second hardware device and the first hardware device, third validation data corresponding to execution of a third instance of the first portion of the software program on the third hardware device. In some examples, the valid execution data is identified based on a comparison of the first validation data and, the second validation data, and the third validation output. In some examples, the third hardware device is a different type of hardware device (e.g., at least one hardware component is different and/or includes a different capability (e.g., more memory)) than the first hardware device and/or the second hardware device. In some examples, the third hardware device is not identical to the first hardware device and/or the second hardware device. In some examples, the software program is not configured before compiling to output the third validation data and instead output of the third validation data is added to the software program (e.g., after initiating compiling of the software program (e.g., while compiling the software program or during execution of the software program)).

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

What is claimed is:

1. A method, comprising:
by a voting service:
receiving, from a process executing on a first hardware device, first validation data corresponding to execution of a first instance of a first portion of a software program on the first hardware device;
receiving, from a process executing on a second hardware device different from the first hardware device, second validation data corresponding to execution of a second instance of the first portion of the software program on the second hardware device;
identifying valid execution data based on a comparison of the first validation data and the second validation data, wherein the valid execution data is output by the first hardware device, the second hardware device, or a third hardware device; and
in response to identifying the valid execution data, causing an operation of the software program to be performed using the valid execution data.

2. The method of claim 1, wherein an instance of a second portion of the software program is executing on the first hardware device, and wherein an instance of the second portion of the software program is not executing on the second hardware device and the third hardware device.

3. The method of claim 1, wherein the voting service is executing on a hardware device performing the operation, and wherein the voting service identifies the valid execution data in response to receiving data from only two hardware devices selected from a group consisting of the first hardware device, the second hardware device, and the third hardware device.

4. The method of claim 1, wherein the voting service is executing on a hardware device performing the operation, and wherein the voting service identifies the valid execution data after receiving an indication of execution data from only one hardware device selected from a group consisting of the first hardware device, the second hardware device, and the third hardware device.

5. The method of claim 4, further comprising:
in response to determining that the valid execution data is different from execution data corresponding to the indication of execution data, sending, to a hardware device producing the valid execution data, a request to output the valid execution data.

6. The method of claim 1, further comprising:
in accordance with a determination that the valid execution data is stored in shared memory of the voting service, causing the operation to be performed includes outputting the valid execution data to a consumer of the valid execution data, wherein the voting service is executing on a hardware device selected from a group consisting of the first hardware device, the second hardware device, and the third hardware device.

7. The method of claim 1, wherein at least one hardware device selected from a group of hardware devices consisting of the first hardware device, the second hardware device, and the third hardware device is a different type of hardware device.

8. The method of claim 1, wherein the validation data is a checksum of at least a portion of execution data.

9. The method of claim 1, further comprising:
receiving, from a process executing on a third hardware device different from the second hardware device and the first hardware device, third validation data corresponding to execution of a third instance of the first portion of the software program on the third hardware device, wherein the valid execution data is identified based on a comparison of the first validation data and, the second validation data, and the third validation output.

10. A non-transitory computer-readable storage medium storing one or more programs configured to be executed by one or more processors of a computer system, the one or more programs including instructions for:
receiving, from a process executing on a first hardware device, first validation data corresponding to execution of a first instance of a first portion of a software program on the first hardware device;
receiving, from a process executing on a second hardware device different from the first hardware device, second validation data corresponding to execution of a second instance of the first portion of the software program on the second hardware device;
identifying valid execution data based on a comparison of the first validation data and the second validation data, wherein the valid execution data is output by the first hardware device, the second hardware device, or a third hardware device; and
in response to identifying the valid execution data, causing an operation of the software program to be performed using the valid execution data.

11. A computer system, comprising:
one or more processors; and
memory storing one or more programs configured to be executed by the one or more processors, the one or more programs including instructions for:
receiving, from a process executing on a first hardware device, first validation data corresponding to execution of a first instance of a first portion of a software program on the first hardware device;
receiving, from a process executing on a second hardware device different from the first hardware device, second validation data corresponding to execution of a second instance of the first portion of the software program on the second hardware device;
identifying valid execution data based on a comparison of the first validation data and the second validation data, wherein the valid execution data is output by the first hardware device, the second hardware device, or a third hardware device; and
in response to identifying the valid execution data, causing an operation of the software program to be performed using the valid execution data.
